(19) United States
(12) Patent Application Publication
(10) Pub. No.: US 2003/0038178 A1
(43) Pub. Date: Feb. 27, 2003

(54) Device for monetary transactions between magnetic media provided with rewritable permanent memory

(76) Inventor: Vittorio Pareti, Herrsching (DE)

Correspondence Address: Mr. Keith K. Nicolls, McCaleb, Lucas & Brugman, 1 S 376 Summit Avenue, Court C, Oakbrook Terrace, IL, 60181, US

(21) Appl. No.: 09/939,501

(22) Filed: Aug. 24, 2001

(51) Int. Cl. G06K 7/08

(52) U.S. Cl. 235/449

(57) ABSTRACT

A device for monetary transactions between magnetic media provided with rewritable permanent memory, comprising, within a containment and support structure, a control and identification unit (13), which is associated with two or more devices (14, 15) for reading/writing magnetic media having one or more rewritable permanent memories. with one or more transfer memories (17) for the two or more media, and with input/output 10 interfacing means (18) which are available to the action or perception of the user. The two or more reading/writing devices are adapted, in cooperation with the two or more memories, if enabled by the control and under the control of the interfacial means to define changes to the state of the memories of the two or more media which are equivalent to monetary transactions.

The present invention relates to a device which is particularly but not exclusively useful for monetary transactions between magnetic media provided with rewritable permanent memory. It is known that a veritable revolution in terms of monetary transactions is currently in progress. Equipment and instruments for electronic trading and for monetary transactions performed over a data network between two or more computers are in fact already available.

Up to now, however although there is development of innovative information-technology means, there has not been a matching adequate development of means which allow monetary transactions between individuals.

Magnetic cards are now widely used in fact allow the user to perform a debit or credit monetary transaction only with other machines, which are directly connected to banking institutions or by means of appropriately provided instrument installed in shops or points of sale which are connected to dedicated networks and in any case interface automatically with said banking institutions.

The aim of the present invention is to provide a device which is for monetary transactions between magnetic media provided with rewritable permanent memory which supercedes the concept of monetary transactions by means of paper money between two or more users.

Within this aim, an important object of the present invention is to provide a device which is highly secure in terms of resistance to attack and tampering of the transaction values determined by the users who set up said transaction.

Another object of the present invention is to provide a device which is easily portable, equally easy to use and for which particular technical and information-technology skills are not necessary.

Another object of the present invention is to provide a device which is be easily interfaced with transactions device which are associated for example with credit institutions. shops or others.

Another object of the present invention is to provide a device which is highly flexible and can be manufactured with a known technologies and systems at costs which are competitive with respect to device having a similar functionality.

This aim and these and other objects which will become better apparent hereinafter are achieved by a device for monetary transactions between magnetic media provided with rewritable permanent memory characterized in that it comprises, within a containment and support structure, a control and identification unit, which is associated with at least two devices for reading/writing magnetic media. having at least one rewritable permanent memory, with at least one transfer memory for said at least two media, and with input/output interface means which are available to the action and/or perception of the users said at least two reading/writing devices being updated in cooperation with said at least one memory, if enable by said control unit and under the control of said interfacing means to define changes to the state of the memories of said at least two media which are equivalent to monetary transactions. Further characteristic and advantages of the present invention will become better apparent from thc description of an embodiment thereof, illustrated only by way of non-limitative example in the accompanying drawings, wherein:

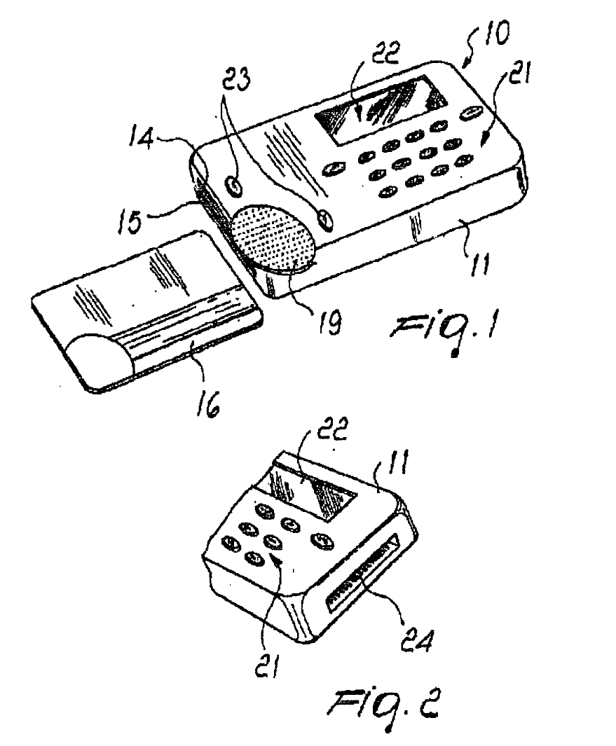

FIG. 1 is a perspective view of a device according to the invention;

FIG. 2 is a perspective view of a portion of the device which is not visible in FIG. 1

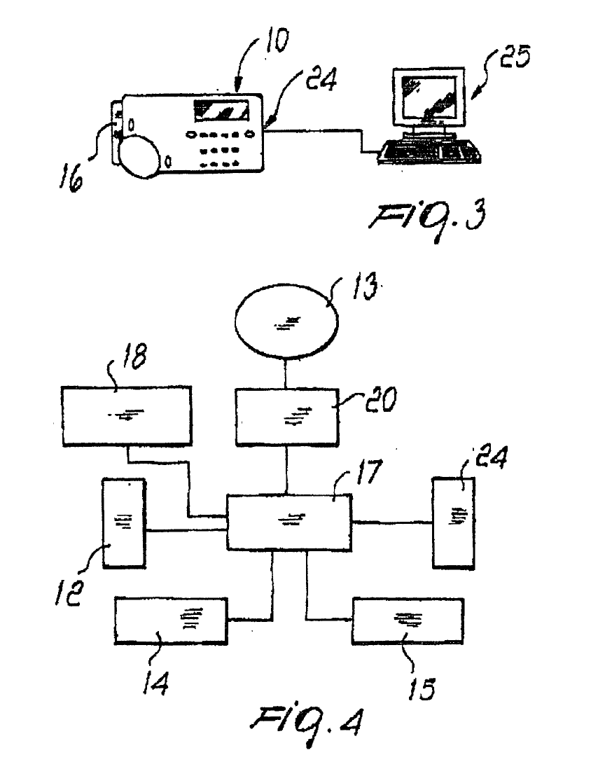

FIG. 3 is schematic view of the connection of the device to an electronic computer which identifies the uploading or downloading of monetary accounts performed by means of banking institutions or the like;

FIG. 4 is a block diagram of the device FIG. 1.

With particular FIGS. 1 to 4, a device for monetary transactions according to the invention is generally designated by the reference numeral 10.

The device 10 comprises in a containment structure 11, which in this case is a box-like portable and provided with a power supply unit (which is autonomous and optionally replaceable or rechargeable), designated by the reference numeral 12 and shown schematically as a block in FIG. 4, and identification and control unit, block 13, which in this case is associated with: two reading/writing devices, blocks 14 and 15 respectively having visually available pictorial or other identification data for the respective parties to the transaction; for magnetic media which in this case are constituted by a corresponding number of commonly used and commercially available magnetic cards 16, a transfer memory, block 17, for said cards 16 and input/output interfacing means, block 18, which are available to the action and/or perception of the user and are described in greater detail hereinafter.

The devices 14 and 15 are adapted to cooperate with the memory 17, after being enabled by the control unit 13 and on command of said means 18, 10 to define changes to the state of the memories (typically of the rewritable permanent type) of said media or cards 16 which are equivalent to monetary transactions.

In particular, the identification unit 13 is constituted by a fingerprint identification device, designated by the reference numeral 19 (for example an optical-fiber reader), optionally combined with a code or password identification device (not shown).

The device 10 also comprises a microprocessor block, 20, which is adapted to ensure the correct 5 placement of data in the memory 17 (encoding and decoding of the data of the identification device 19 in order to compare them with the stored data) and is also adapted to coordinate the entire transaction. of the cards 16 placed in the devices 14 and 15.

The interfacial means, in this embodiment, are connected by an alphanumeric keyboard 21 (which is at least partially visible on the outside of the box-like structure 11) an alphanumeric liquid-crystal display 22, and on/off buttons 23 for memories and input/output devices such as a connection interface 24.

In practice, operation is as follows; when two or more users wish to perform a monetary transaction without using paper money, they can use, for this transaction the ordinary magnetic cards used for transactions with bank tellers or in shops.

These cards are conveniently “topped up” by transferring data by means of telecommunication interface 24, from the trusted bank institution (computer 25 of FIG. 3) which manages, for example, the current account of each user.

In practice, each card, after topping-up, behaves like a virtual wallet which contains a certain amount of money; this amount can increase or decrease according to the type of transaction (purchase or sale in kind of cash), and the device 10 behaves like a unit for transferring money from one card to the other without performing a physical money transfer.

The cards 16 or other equivalent storage devices are inserted in the readers 14 and 15, and by appropriately setting the values of the transaction, the microprocessor 20, in cooperation with said devices 14 and 15 and by using the transfer memory 17, performs the monetary transaction.

The transactions performed during the day or during a preset period of time can then be appropriately downloaded to the trusted credit institution, or it is possible to perform a new top-up when the amount of money available in a card has been used up.

In practice it has been observed that the present invention has achieved the intended aim and objects.

In particular it is noted that the device according to the invention eliminates, in a substantially final manner, use of paper money thereby reducing the risk of everything that is linked thereto, for example theft, loss and in any case deterioration and use of a physical medium (money) which inherently has great portability limitations.

It should also be noted that the device according to the to the invention can ensure higher security of the transactions preventing forgeries or anything else that can prevent the correct crediting of transacted amounts.

Moreover, it should be noted that the device according to the invention can be directly interfaced with credit institutions or other equivalent institutions for management of monetary transactions.

By ensuring that each operation interfacing with the credit institution, was certified with a receipt, all transactions would be recorded and “off-the-books” payments would become impossible.

The present invention is susceptible of numerous modifications and, variations, all of which are within the scope of thc inventive concept as set out in the following appended claims.

The technical details may be replaced with other technically equivalent elements. The materials and the dimensions may be any according to the requirements.

Where technical features mentioned in any claim are followed by reference signs, those reference signs have been included for the sole purpose of increasing the intelligibility of the claims and accordingly such reference signs do not have any limiting effect on the scope of each element identified by way of example by such reference signs.

I claim:

1. A device for monetary transactions between magnetic media provided with rewritable permanent memory, characterized in that it comprises with a containment and support structure, a control and identification unit, which is associated with at least two devices for reading/writing magnetic media having at least one rewritable permanent memory, with at least one transfer memory for said at least two media, and with input/output interfacing means which are available to the action and/or perception of the user; said at least two reading/writing devices being adapted in cooperation with said at least one memory, if enabled by said control unit and under the control of said interfacing means, to define changes to the state of the memories of said at least two media which are equivalent to monetary transactions.

2. The device according to claim 1, characterized in that said containment and support structure is of the box-like type and is provided with an autonomous power supply unit.

3. The device according to claim 2, characterized in that said power supply unit is rechargeable.

4. The device according to one or more of the preceding claims, characterized in that said identification unit comprises at least one fingerprint identification device.

5. The device according to one or more of the preceding claims, characterized in that said identification unit comprises at lease one code and/or password identification device.

6. The device according to one or more of the preceding claims, characterized in that it comprises a microprocessor which is associated with said at least one transfer memory and with at least one input/output reader device for managing the monetary transaction.

7. The device according to one or more of the preceding claims, characterized in that said interfacing means are constituted by a keyboard.

8. The device according to one or more of the preceding claims, characterized in that said interfacing means comprise a visual display.

9. The device according to one or more of the preceding claims, characterized in that said interfacing means comprise one or more on/off buttons for memories.

10. The device according to one or more of the preceding claims, characterized in that said interfacing means comprise at least one connection interface.
